(19) United States
(12) Patent Application Publication
(10) Pub. No.: US 2004/0076880 A1
(43) Pub. Date: Apr. 22, 2004

(54) Multiple layer hydrogen electrode

(76) Inventors: Stanford R. Ovshinsky, Bloomfield Hills, MI (US); Srinivasan Venkatesan, Southfield, MI (US); Hong Wang, Troy, MI (US); Boyko Aladjov, Rochester Hills, MI (US); Subhash Dhar, Bloomfield, MI (US)

Correspondence Address: ENERGY CONVERSION DEVICES, INC., 2956 WATERVIEW DRIVE, ROCHESTER HILLS, MI, 48309, US

(21) Appl. No.: 10/273,509

(22) Filed: Oct. 18, 2002

(51) Int. Cl. H01M 4/58

(52) U.S. Cl. 429/218.2

(57) ABSTRACT

A multiple layered hydrogen electrode with a carbon based gas diffusion layer and an active material layer. The carbon based gas diffusion layer uniformly distributes hydrogen across the electrode while maintaining hydrophobicity within the gas diffusion layer. The design of the hydrogen electrode provides stability and promotes hydrogen dissociation and absorption within the hydrogen electrode.

### FIELD OF THE INVENTION

The present invention generally relates to hydrogen electrodes utilized in a variety of fuel cells. More particularly, the present invention relates to hydrogen electrodes having a carbon based gas diffusion layer and an active material layer.

### BACKGROUND

As the world's population expands and its economy increases, the atmospheric concentrations of carbon dioxide are warming the earth causing climate change. However, the global energy system is moving steadily away from the carbon-rich fuels whose combustion produces the harmful gas. Experts say atmospheric levels of carbon dioxide may be double that of the pre-industrial era by the end of the next century, but they also say the levels would be much higher except for a trend toward lower-carbon fuels that has been going on for more than 100 years. Furthermore, fossil fuels cause pollution and are a causative factor in the strategic military struggles between nations. Furthermore, fluctuating energy costs are a source of economic instability worldwide.

In the United States, it is estimated, that the trend toward lower-carbon fuels combined with greater energy efficiency has, since 1950, reduced by about half the amount of carbon spewed out for each unit of economic production. Thus, the decarbonization of the energy system is the single most important fact to emerge from the last 20 years of analysis of the system. It had been predicted that this evolution will produce a carbon-free energy system by the end of the 21^{st} century. The present invention is another product which is essential to shortening that period to a matter of years. In the near term, hydrogen will be used in fuel cells for cars, trucks and industrial plants, just as it already provides power for orbiting spacecraft. But, with the problems of storage and infrastructure solved (see U.S. application Ser. No. 09/444,810, entitled “A Hydrogen-based Ecosystem” filed on Nov. 22, 1999 for Ovshinsky, et al., which is herein incorporated by reference and U.S. patent application Ser. No. 09/435,497, entitled “High Storage Capacity Alloys Enabling a Hydrogen-based Ecosystem”, filed on Nov. 6, 1999 for Ovshinsky et al., which is herein incorporated by reference), hydrogen will also provide a general carbon-free fuel to cover all fuel needs.

A dramatic shift has now occurred, in which the problems of global warming and climate change are now acknowledged and efforts are being made to solve them. Therefore, it is very encouraging that some of the world's biggest petroleum companies now state that they want to help solve these problems. A number of American utilities vow to find ways to reduce the harm done to the atmosphere by their power plants. DuPont, the world's biggest chemicals firm, even declared that it would voluntarily reduce its emissions of greenhouse gases to 35% of their level in 1990 within a decade. The automotive industry, which is a substantial contributor to emissions of greenhouse gases and other pollutants (despite its vehicular specific reductions in emissions), has now realized that change is necessary as evidenced by their electric and hybrid vehicles.

Hydrogen is the “ultimate fuel.” In fact, it is considered to be “THE” fuel for the future. Hydrogen is the most plentiful element in the universe (over 95%). Hydrogen can provide an inexhaustible, clean source of energy for our planet which can be produced by various processes. Utilizing the inventions of subject assignee, the hydrogen can be stored and transported in solid state form in trucks, trains, boats, barges, etc. (see the '810 and '497 applications).

A fuel cell is an energy-conversion device that directly converts the energy of a supplied gas into an electric energy. Researchers have been actively studying fuel cells to utilize the fuel cell's potential high energy-generation efficiency. The base unit of the fuel cell is a cell having an oxygen electrode, a hydrogen electrode, and an appropriate electrolyte. Fuel cells have many potential applications such as supplying power for transportation vehicles, replacing steam turbines and power supply applications of all sorts. Despite their seeming simplicity, many problems have prevented the widespread usage of fuel cells.

Presently most of the fuel cell R & D focus is on P.E.M. (Proton Exchange Membrane) fuel cells. The P.E.M. fuel cell suffers from relatively low conversion efficiency and has many other disadvantages. For instance, the electrolyte for the system is acidic. Thus, noble metal catalysts are the only useful active materials for the electrodes of the system. Unfortunately, not only are the noble metals costly, they are also susceptible to poisoning by many gases, and specifically carbon monoxide (CO). Also, because of the acidic nature of the P.E.M fuel cell, the remainder of the materials of construction of the fuel cell need to be compatible with such an environment, which again adds to the cost thereof. The proton exchange membrane itself is quite expensive, and because of its low conductivity, inherently limits the power performance and operational temperature range of the P.E.M. fuel cell (the PEM is nearly non-functional at low temperatures, unlike the fuel cell of the instant invention). Also, the membrane is sensitive to high temperatures, and begins to soften at 120° C. The membrane's conductivity depends on water and dries out at higher temperatures, thus causing cell failure. Therefore, there are many disadvantages to the P.E.M. fuel cell which make it somewhat undesirable for commercial/consumer use.

The conventional alkaline fuel cell has some advantages over P.E.M. fuel cells in that they have higher operating efficiencies, they use less expensive materials of construction, and they have no need for expensive membranes. The alkaline fuel cell also has relatively higher ionic conductivity in the electrolyte, therefore it has a much higher power capability. Unfortunately, conventional alkaline fuel cells still suffer from certain disadvantages. For instance, conventional alkaline fuel cells still use expensive noble metals catalysts in both electrodes, which, as in the P.E.M. fuel cell, are susceptible to gaseous contaminant poisoning. While the conventional alkaline fuel cell is less sensitive to temperature than the PEM fuel cell, the active materials of conventional alkaline fuel cell electrodes become very inefficient at low temperatures.

Fuel cells, like batteries, operate by utilizing electrochemical reactions. Unlike a battery, in which chemical energy is stored within the cell, fuel cells generally are supplied with reactants from outside the cell. Barring failure of the electrodes, as long as the fuel, preferably hydrogen, and oxidant, typically air or oxygen, are supplied and the reaction products are removed, the cell continues to operate.

Fuel cells offer a number of important advantages over internal combustion engine or generator systems. These include relatively high efficiency, environmentally clean operation especially when utilizing hydrogen as a fuel, high reliability, few moving parts, and quiet operation. Fuel cells potentially are more efficient than other conventional power sources based upon the Carnot cycle.

The major components of a typical fuel cell are the hydrogen electrode for hydrogen oxidation and the oxygen electrode for oxygen reduction, both being positioned in a cell containing an electrolyte (such as an alkaline electrolytic solution). Typically, the reactants, such as hydrogen and oxygen, are respectively fed through a porous hydrogen electrode and oxygen electrode and brought into surface contact with the electrolytic solution. The particular materials utilized for the hydrogen electrode and oxygen electrode are important since they must act as efficient catalysts for the reactions taking place.

In an alkaline fuel cell, the reaction at the hydrogen electrode occurs between the hydrogen fuel and hydroxyl ions (OH⁻) present in the electrolyte, which react to form water and release electrons:

H₂+2OH⁻→2H₂O+2e⁻.

At the oxygen electrode, the oxygen, water, and electrons react in the presence of the oxygen electrode catalyst to reduce the oxygen and form hydroxyl ions (OH⁻):

O₂+2H₂O+4e⁻→4OH⁻.

The flow of electrons is utilized to provide electrical energy for a load externally connected to the hydrogen and oxygen electrodes.

The present invention discloses a multiple layer hydrogen electrode with a carbon based gas diffusion layer. The carbon based gas diffusion layer provides for numerous capillaries and fine pore sizes within the gas diffusion layer resulting in uniform distribution of hydrogen across the face of the hydrogen electrode, thus avoiding increases in local current densities and local polarization within the hydrogen electrode. The design of the hydrogen electrode of the present invention also allows for up to 60 weight percent of polytetrafluoroethylene in the gas diffusion layer thus providing greater hydrophobicity within the gas diffusion layer. The multiple layer structure of the hydrogen electrode also promotes stability within the hydrogen electrode.

### SUMMARY OF THE INVENTION

The present invention discloses a multiple layer hydrogen electrode comprising a gas diffusion layer with a built-in hydrophobic character and an active material layer providing for storage of hydrogen. The active material layer is designed to contact an electrolyte stream whereas the gas diffusion layer is designed to contact a gaseous hydrogen stream. A first current collector grid is disposed adjacent to the gas diffusion layer opposite the active material and a second current collector grid is disposed adjacent to the active material layer opposite the gas diffusion layer. The current collector grids comprise at least one selected from the group consisting of mesh, grid, matte, expanded metal, foil, foam and plate.

The gas diffusion layer comprises a carbon matrix composed of a plurality carbon particles at least partially coated with polytetrafluoroethylene. The plurality of polytetrafluoroethylene coated carbon particles contain 20-60% polytetrafluoroethylene by weight. The gas diffusion layer has a hydrogen contacting surface and an electrolyte contacting surface wherein the polytetrafluoroethylene may be graded from a high concentration at the electrolyte contacting surface of the gas diffusion layer to a low concentration at the hydrogen contacting surface of the gas diffusion layer.

The active material layer comprises a hydrogen storage material adapted to dissociate and absorb gaseous hydrogen. The hydrogen storage material is a hydrogen storage alloy selected from the group consisting of rare-earth/Misch metal alloys, zirconium alloys, titanium alloys, and mixtures or alloys thereof. Preferably, the hydrogen storage material is a hydrogen storage alloy having composition: (Mm)ₐNi_{b}Co_{c}Mn_{d}Alₑ

where Mm is a Misch Metal comprising 60 to 67 atomic percent La, 25 to 30 weight percent Ce, 0 to 5 weight percent Pr, 0 to 10 weight percent Nd; b is 45 to 55 weight percent; c is 8 to 12 weight percent; d is 0 to 5.0 weight percent; e is 0 to 2.0 weight percent; and a+b+c+d+e=100 weight percent.

The active material layer has a hydrogen contacting surface and an electrolyte contacting surface wherein the active material layer has a layer of material catalytic to the dissociation of hydrogen on said hydrogen contacting surface and a layer of material catalytic to the formation of water from hydrogen and hydroxyl ions on said electrolyte contacting surface.

### BRIEF DESCRIPTION OF THE DRAWINGS

FIG. 1, is a plot of the current density versus the electrode potential for the multiple layer hydrogen electrode in accordance with the present invention.

FIG. 2, is a plot of the current density versus the electrode potential for a conventional single layer hydrogen electrode.

FIG. 3, shows a depiction of a multiple layer hydrogen electrode in accordance with the present invention.

### DETAILED DESCRIPTION OF THE INVENTION

The present invention discloses multiple layer hydrogen electrodes having a carbon based gas diffusion layer. These electrodes are easily prepared and have excellent reproducibility. By using carbon in the gas diffusion layer rather than nickel, greater amounts of polytetrafluoroethylene are able to be incorporated into the gas diffusion layer thus providing increased hydrophobicity allowing for uniform hydrogen distribution. Carbon also provides a higher surface area within the electrode as compared to nickel. Non-uniform hydrogen distribution within the hydrogen electrode increases the local current densities and creates large local polarization thus reducing efficiency within the fuel cell. By maintaining uniform hydrogen distribution across the hydrogen electrode, efficient operation of the fuel cell utilizing the hydrogen electrode will be maintained. The carbon also has a much smaller packing density as compared to nickel and capillaries used for the transfer of hydrogen within the electrode are more numerous when using carbon. The carbon also has a much larger surface area and a lower density than nickel.

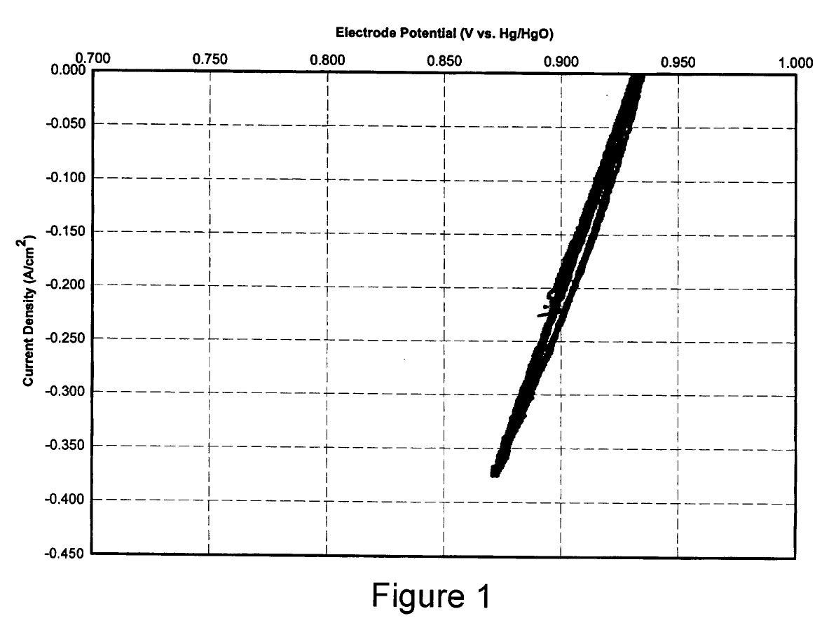

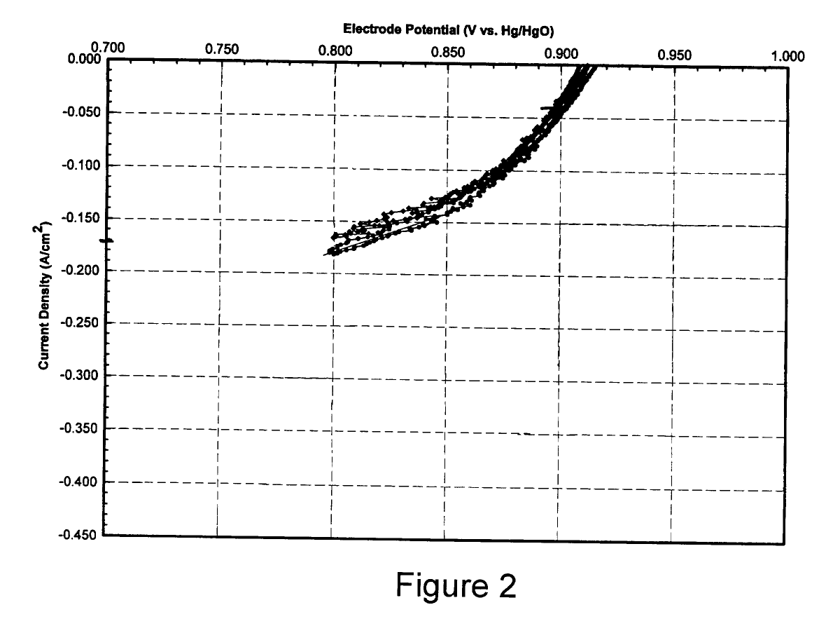

FIG. 1 is a plot of the current density versus the electrode potential for the multiple layer hydrogen electrode in accordance with the present invention. FIG. 2 is a plot of the current density versus the electrode potential of a conventional single layer hydrogen electrode. The scan rates of the curves shown in FIG. 1 and FIG. 2 are both at 1 mA/sec. The curve shown in FIG. 1 is a straight line while the curve shown in FIG. 2 has a curvature. This means that the single layer electrode is reaching a limiting current which does not allow the single layer electrode to keep up with the demand for current. The straight line shown in FIG. 1 also a much greater slope than the line shown in FIG. 2. This means that polarization within the multiple layer hydrogen electrode is considerably less than the polarization in the conventional single layer hydrogen electrode. The polarization in the multiple layer hydrogen electrode is minimal due to uniform hydrogen distribution within the electrode. FIG. 1 and FIG. 2 also show that the multiple layer electrode is capable of providing a much larger current density as compared to the conventional single layer electrode.

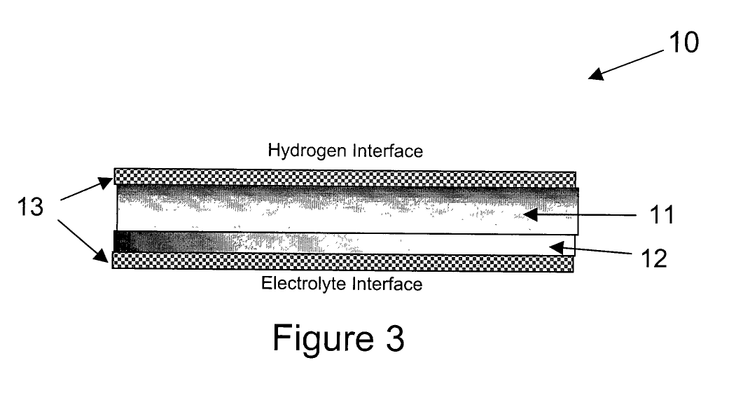

The multiple layer hydrogen electrode 10 in the preferred embodiment of the present invention has a layered structure and is exemplified in FIG. 3. The layered structure promotes uniform hydrogen distribution across the face of the hydrogen electrode and absorption of the hydrogen into the active material layer. The multiple layer hydrogen electrode 10 is composed of a gas diffusion layer 11, an active material layer 12, and two current collector grids 13. The gas diffusion layer and the active material layer are placed adjacent to one another with the current collector grids 13 being placed outside the gas diffusion layer 11 and active material layer 12 thereby forming a sandwich configuration. When used inside a fuel cell, the current collector grid in contact with the active material layer 12 is in contact with the electrolyte stream while the current collector grid in contact with the gas diffusion layer 11 is in contact with the hydrogen stream. By using two current collector grids, additional stability is provided to the electrode thereby resulting in a longer lifetime for the electrode. While the preferred embodiment of the invention includes a gas diffusion layer and an active material layer, alternative embodiments of the invention may include additional active material layers or gas diffusion layers to vary the hydrophobicity within the electrode as needed.

The hydrogen electrode needs a barrier means to isolate the electrolyte, or wet, side of the hydrogen electrode from the gaseous, or dry, side of the hydrogen electrode. A beneficial means of accomplishing this is by inclusion of a hydrophobic component comprising a halogenated organic polymer compound, particularly polytetrafluoroethylene (PTFE) within the gas diffusion layer of the hydrogen electrode to prevent the electrolyte from entering the gas diffusion layer from the active material layer. With this in mind, the gas diffusion layer 11 is primarily a carbon matrix composed of carbon particles coated with polytetrafluoroethylene. The carbon matrix is in intimate contact with a current collector grid which provides mechanical support to the carbon matrix. The carbon particles may be carbon black known as Vulcan XC-72 carbon (Trademark of Cabot Corp.), which is well known in the art. The gas diffusion layer may contain approximately 20-60 percent by weight polytetrafluoroethylene with the remainder consisting of carbon particles. The use of carbon particles rather than materials like nickel in the gas diffusion layer allows the amount of polytetrafluoroethylene to vary as needed up to 60 weight percent without clogging the pores in the gas diffusion layer. The polytetrafluoroethylene concentration within the gas diffusion layer may also be continually graded from a high concentration at the side of the gas diffusion layer contacting the active material layer to a low concentration at the side of the gas diffusion layer contacting the current collector grid.

The active material layer 12 of the instant invention is generally a hydrogen storage material optionally including a catalytic material. The preferable active material layer is one which can reversibly absorb and release hydrogen irrespective of the hydrogen storage capacity and has the properties of a fast hydrogenation reaction rate, a good stability in the electrolyte, and a long shelf-life. It should be noted that, by hydrogen storage capacity, it is meant that the material stores hydrogen in a stable form, in some nonzero amount higher than trace amounts. Preferred materials will store about 1.0 weight % hydrogen or more. Preferably, the alloys include, for example, rare-earth/Misch metal alloys, zirconium and/or titanium alloys or mixtures thereof. The active material layer may even be layered such that the material on the hydrogen contacting surface of the active material layer is formed from a material which has been specifically designed to be highly catalytic to the dissociation of molecular hydrogen into atomic hydrogen, while the material on the electrolyte contacting surface is designed to be highly catalytic to the oxidation of hydrogen.

Certain hydrogen storage materials are exceptionally useful as alkaline fuel cell hydrogen electrode materials. The useful hydrogen storage alloys have excellent catalytic activity for the formation of hydrogen ions from molecular hydrogen and also have superior catalytic activity toward the formation of water from hydrogen ions and hydroxyl ions. In addition to having exceptional catalytic capabilities, the materials also have outstanding corrosion resistance toward the alkaline electrolyte of the fuel cell. In use, the alloy materials act as 1) a molecular hydrogen decomposition catalyst throughout the bulk of the hydrogen electrode; and 2) as an internal hydrogen storage buffer to insure that a ready supply of hydrogen atoms is always available at the electrolyte contacting surface.

Specific alloys useful as the anode material are alloys that contain enriched catalytic nickel regions of 50-70 Angstroms in diameter distributed throughout the oxide interface which vary in proximity from 2-300 Angstroms preferably 50-100 Angstroms, from region to region. As a result of these nickel regions, the materials exhibit significant catalysis and conductivity. The density of Ni regions in the alloys provide powder particles having an enriched Ni surface. The most preferred alloys having enriched Ni regions are alloys having the following composition: (Mm)ₐNi_{b}Co_{c}Mn_{d}Alₑ

where Mm is a Misch Metal comprising 60 to 67 atomic percent La, 25 to 30 weight percent Ce, 0 to 5 weight percent Pr, 0 to 10 weight percent Nd; b is 45 to 55 weight percent; c is 8 to 12 weight percent; d is 0 to 5.0 weight percent; e is 0 to 2.0 weight percent; and a+b+c+d+e=100 weight percent.

The current collector grids in accordance with the present invention may be selected from, but not limited to, an electrically conductive mesh, grid, foam, expanded metal, or combination thereof. The most preferable current collector grid is an electrically conductive mesh having 40 wires per inch horizontally and 20 wires per inch vertically, although other meshes may work equally well. The wires comprising the mesh may have a diameter between 0.005 inches and 0.01 inches, preferably between 0.005 inches and 0.008 inches. This design provides optimal current distribution due to the reduction of the ohmic resistance. Where more than 20 wires per inch are vertically positioned, problems may be encountered when affixing the active material to the substrate. One current collector grid may be used in accordance with the present invention, however the use of two current collector grids is preferred thus increasing the mechanical integrity of the oxygen electrode.

The gas diffusion layer of the hydrogen electrode in accordance with the present invention is prepared by at least partially coating carbon particles with polytetrafluoroethylene (PTFE). The carbon particles are preferably carbon black known as Vulcan XC-72 carbon (Trademark of Cabot Corp.), which is well known in the art. The PTFE/carbon mixture contains approximately 20 to 60 percent PTFE by weight. The polytetrafluoroethylene coated carbon particles are then placed in a roll mill. The roll mill produces a ribbon of the gas diffusion layer with a thickness ranging from 0.018 to 0.02 inches as desired.

The active material layer of the hydrogen electrode in accordance with the present invention is prepared by placing the active material into a roll mill. The roll mill produces a ribbon of the active material layer having a thickness ranging from 0.018 to 0.02 inches as desired.

Once the ribbons of active material layer and gas diffusion layer have been produced, the layers are placed back to back with one current collector grid placed on each side. The layers and the current collector grids are then rerolled and sintered to form the multiple layer hydrogen electrode.

The foregoing is provided for purposes of explaining and disclosing preferred embodiments of the present invention. Modifications and adaptations to the described embodiments, particularly involving changes to the shape and design of the hydrogen electrode, the type of active material, and the type of carbon used, will be apparent to those skilled in the art. These changes and others may be made without departing from the scope or spirit of the invention in the following claims.

1. A hydrogen electrode comprising:
a gas diffusion layer having a built-in hydrophobic character;
an active material layer providing for storage of hydrogen;
a first current collector grid disposed adjacent to said gas diffusion layer opposite said active material layer; and
a second current collector grid disposed adjacent to said active material layer opposite said gas diffusion layer.

2. The hydrogen electrode according to claim 1, wherein said active material layer is designed to contact an electrolyte stream.

3. The hydrogen electrode according to claim 1, wherein said gas diffusion layer is designed to contact a gaseous hydrogen stream.

4. The hydrogen electrode according to claim 1, wherein said gas diffusion layer comprises a carbon matrix.

5. The hydrogen electrode according to claim 4, wherein said carbon matrix comprises a plurality carbon particles at least partially coated with polytetrafluoroethylene.

6. The hydrogen electrode according to claim 5, wherein said plurality of polytetrafluoroethylene coated carbon particles contain 20-60% polytetrafluoroethylene by weight.

7. The hydrogen electrode according to claim 5, wherein said gas diffusion layer has a hydrogen contacting surface and an electrolyte contacting surface.

8. The hydrogen electrode according to claim 7, wherein said polytetrafluoroethylene is graded from a high concentration at said electrolyte contacting surface of said gas diffusion layer to a low concentration at said hydrogen contacting surface of said gas diffusion layer.

9. The hydrogen electrode according to claim 1, wherein said active material layer comprises a hydrogen storage material.

10. The hydrogen electrode according to claim 9, wherein said hydrogen storage material is a hydrogen storage alloy selected from the group consisting of rare-earth/Misch metal alloys, zirconium alloys, titanium alloys, and mixtures or alloys thereof.

11. The hydrogen electrode according to claim 10, wherein said hydrogen storage alloy has the following composition: (Mm)ₐNi_{b}Co_{c}Mn_{d}Alₑ
where Mm is a Misch Metal comprising 60 to 67 atomic percent La, 25 to 30 weight percent Ce, 0 to 5 weight percent Pr, 0 to 10 weight percent Nd; b is 45 to 55 weight percent; c is 8 to 12 weight percent; d is 0 to 5.0 weight percent; e is 0 to 2.0 weight percent; and a+b+c+d+e=100 weight percent.

12. The hydrogen electrode according to claim 1, wherein said active material layer has a hydrogen contacting surface and an electrolyte contacting surface.

13. The hydrogen electrode according to claim 12, wherein said active material layer has a layer of material catalytic to the dissociation of hydrogen on said hydrogen contacting surface.

14. The hydrogen electrode according to claim 12, wherein said active material layer has a layer of material catalytic to the formation of water from hydrogen and hydroxyl ions on said electrolyte contacting surface.

15. The hydrogen electrode according to claim 1, wherein said first current collector grid and said second current collector grid each comprise at least one selected from the group consisting of mesh, grid, matte, expanded metal, foil, foam and plate.
